(19) United States
(12) Patent Application Publication
(10) Pub. No.: US 2008/0299904 A1
(43) Pub. Date: Dec. 4, 2008

(54) WIRELESS COMMUNICATION SYSTEM

(75) Inventors: Ge Yi, Londonderry (GB); Kai-Zhong Gao, Eden Prairie, MN (US); Song Sheng Xue, Edina, MN (US); Nurul Amin, Woodbury, MN (US); Dexin Wang, Eden Prairie, MN (US)

Correspondence Address: Shumaker & Sieffert, P.A., 1625 Radio Drive, Suite 300, Woodbury, MN, 55125, US

(73) Assignee: Seagate Technology LLC, Scotts Valley, CA (US)

(21) Appl. No.: 11/757,686

(22) Filed: Jun. 4, 2007

(51) Int. Cl. H04B 5/00; H04B 7/00

(52) U.S. Cl. 455/41.1; 455/130; 455/41.2

(57) ABSTRACT

A wireless communication system comprises a first communication module including a transmitter configured to generate a modulated magnetic field and a second communication module including a receiver. The receiver of the second communication module includes a solid magnetic field sensor configured to sense the magnetic field. Information is transferred from the first communication module to the second communication module via the magnetic field.

### TECHNICAL FIELD

The invention relates to a communication system. More particularly, the invention relates to a short-range wireless communication system using magnetic inductive coupling.

### BACKGROUND

Short-range wireless communication systems are used in many different applications, such as to connect wireless accessories to mobile telephones and MP3 players (e.g., wireless headsets), connect medical device programmers to implantable medical devices, keyless entry systems, and so forth. Some wireless communication systems send and receive information, such as voice, data, music, video, and so forth, through radio frequency based technologies (e.g., Bluetooth), infrared technology or magnetic induction.

One example of a short range wireless communication standard is the Near Field Communication (NFC) standard, which is a wireless connectivity standard that relies on magnetic field induction to enable communication between devices. The range for the near field communication is typically about twenty centimeters or less. Due to the relatively short distance between the transmitting device and the receiving device, as well as the relatively short read range of the communication signal in a NFC system, systems based on NFC may be useful for achieving relatively secure communication between devices. The strength of a magnetic field typically decreases with distance (e.g., strength of magnetic field=1/r³, where r is the distance from the magnetic field transmitter). Accordingly, the range of a magnetic field communication signal may be limited to relatively short distances, such as less than three meters. Other short-range wireless communication standards include those based on 802.11x or Bluetooth specification sets, which may be used to enable communication at distances up to 100 meters.

In existing wireless communication systems relying on magnetic induction, a communication device includes a coil (i.e., a solenoid) transmitter to transmit a magnetic field and a coil receiver to sense a magnetic field emitted by another communication device. The effective range of the magnetic field emitted by the coil transmitter is typically proportional to the amplitude of the current provided to the transmitter and the sensitivity of the receiver. The sensitivity of the coil receiver, which affects the read range of the coil receiver, is typically proportional to the number of turns in the coil. Thus, in order to increase the sensitivity and, therefore, the read-range of the coil receiver, the number of turns of the coil receiver is increased. In order to increase the read range of the communication system, the amplitude of the current provided to the transmitter may also be increased. Increasing the number of turns of the coil receiver typically increases the size of the coil receiver, and increasing the amplitude of the current typically increases the power consumption by the coil transmitter.

### SUMMARY

A wireless communication system comprises a first communication module including a transmitter configured to generate a modulated magnetic field and a second communication module including a receiver. The receiver includes a solid magnetic field sensor configured to sense the magnetic field. Information is transferred from the first communication module to the second communication module via the magnetic field.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram of one embodiment of a communication system that includes a communication module including a magnetic field transmitter and another communication module including a solid magnetic field sensor to receive the magnetic field emitted by the transmitter.

FIG. 2 is a schematic perspective view of an embodiment of a transmitter that may be used in at least one of the communication modules of FIG. 1, where the transmitter includes three orthogonally oriented coils.

FIG. 3 is a schematic perspective view of an embodiment of a pancake coil transmitter that may be used in at least one of the communication modules of FIG. 1.

FIG. 4 is yet another embodiment of transmitter system that may be used in at least one of the communication modules of FIG. 1.

FIG. 5 is an embodiment of a magnetoresistive (MR) sensor assembly that may be used in at least one of the communication modules of FIG. 1, where the MR sensor assembly includes three MR sensors that are oriented in different directions.

FIG. 6 is a block diagram of an embodiment of a bidirectional communication system that includes two communication modules.

FIG. 7 is a block diagram of another embodiment of a bidirectional communication system.

FIG. 8 is a schematic perspective view of an application of a communication system in accordance with the invention, in which the communication system is used to transfer data between a personal computing device and an external disc drive.

### DETAILED DESCRIPTION

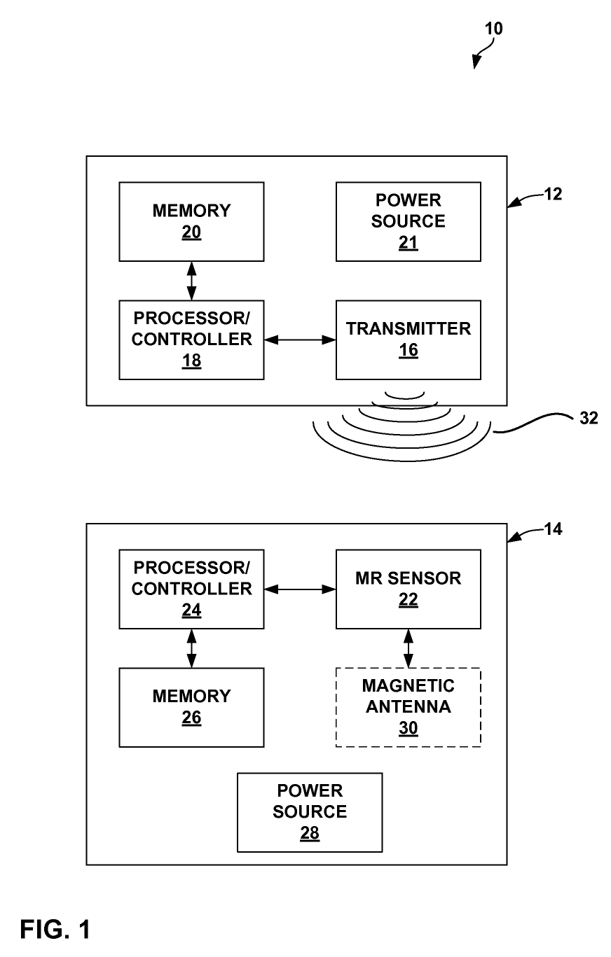

FIG. 1 is a block diagram of communication system 10 that utilizes magnetic induction to send and receive information in accordance with one embodiment of the invention. Communication system 10 includes first communication module 12 and second communication module 14. First communication module 12 includes transmitter 16, processor/controller 18 (hereinafter referred to as processor 18), memory 20, and power source 21. Second communication module includes magnetoresistive (MR) sensor 22, processor/controller 24 (hereinafter referred to as processor 24), memory 26, power source 28, and magnetic antenna 30. Magnetic antenna 30 is optional, and therefore, is shown in phantom lines in FIG. 1.

Communication system 10 enables unidirectional communication between first communication module 12 and second communication module 14 based on magnetic field sensing techniques. That is, in operation, transmitter 16 of first communication module 12 emits a modulated magnetic field 32 under the control of processor 18, and magnetic field 32 is sensed and received by MR sensor 22 of second communication module 14. Modulated magnetic field 32 carries encoded information through amplitude modulation, frequency modulation, phase modulation or any other suitable modulation techniques. “Information” refers generally to any information, such as, but not limited to, data, voice, music, and video. In this way, information is transferred between first and second communication modules 12, 14 via magnetic field 32.

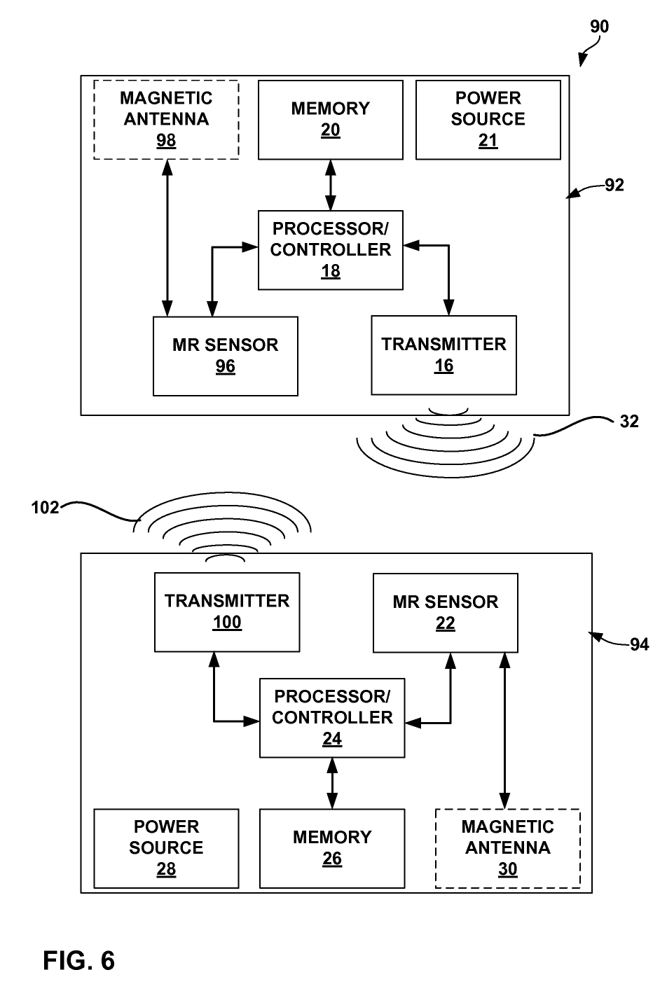

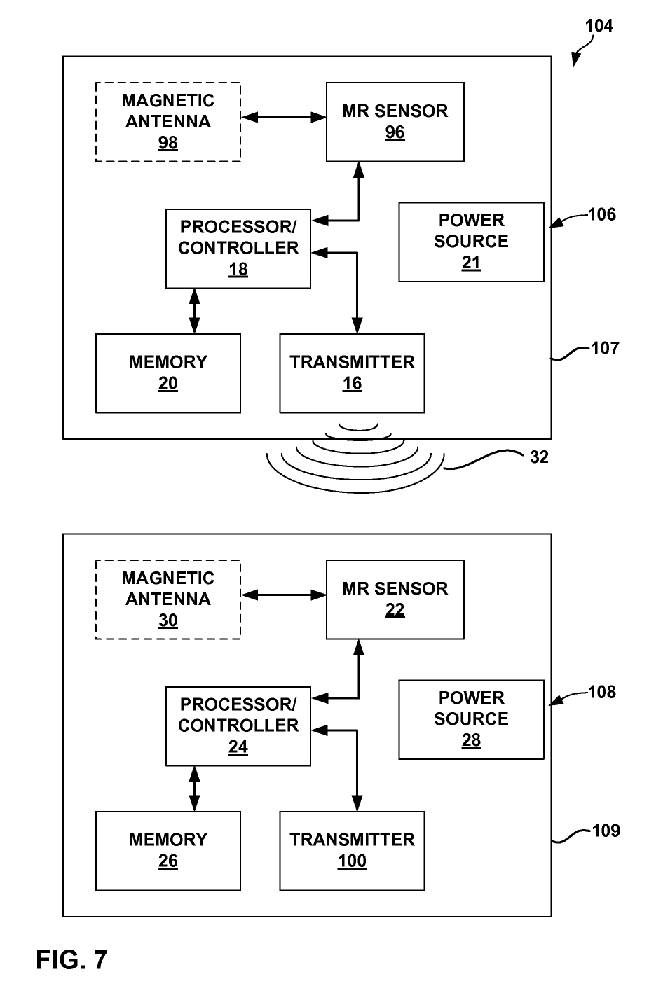

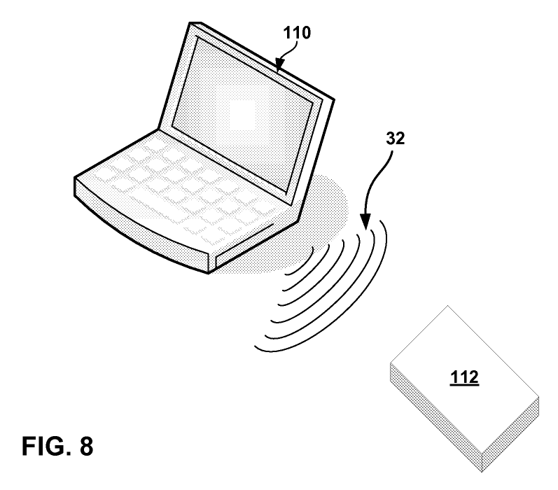

As described in further detail below, MR sensor 22 may convert the sensed magnetic induction from magnetic field 32 into sensor signals. In some embodiments, processor 24 merely controls MR sensor 22 (e.g., turning MR sensor 22 on and off between a sleep state and an on state), while in other embodiments, processor 24 also includes the functionality to process the sensor signals from MR sensor 22. For example, processor 24 may include a demodulator to demodulate sensed magnetic field 32. Communication systems that support bidirectional communication between communication modules are shown in FIGS. 6 and 7, and described with reference to FIGS. 6 and 7.

Communication systems relying on radio frequency signals, such as communication systems based on 802.11x or Bluetooth specification sets, may be subject to interference from neighboring communication devices. One cause of interference in radio frequency-based communication systems is an electric field that is emitted by a transmitting device during the transmission of radio frequency signals, which unintentionally and effectively couples two communication modules together. Interference between modules 12, 14 of communication system 10 and adjacent communication systems and/or modules is minimized compared to systems that rely on radio frequency bands because the electric field in magnetic induction-based systems is minimized, and in some cases, the electric field may be nearly absent. In addition, the likelihood of interference in a communication system relying on magnetic induction may be decreased because communication system 10 operates in a lower frequency band that is not as congested as the higher frequency bands of 802.11x or Bluetooth specification sets.

Transfer of information between two communication modules 12, 14 by magnetic field sensing is a relatively low power technique for data transfer as compared to other radio frequency (RF) based technologies, such the 802.11x or Bluetooth specification sets. For example, it has been found that a typical magnetic induction transmitter chipset may draw as little as seven milliamps (mA) of power to transmit voice or data across an approximately one meter link. RF based technologies, on the other hand, may require up to ten times or more the power as a magnetic induction chipset to transmit the same amount of voice or data across the same distance. The relatively low power requirements of transmitter 16 and receiver 22 may help minimize a size of communication modules 12, 14, respectively, because the size of power sources 21 and 28 may be related to the power consumption levels of communication modules 12, 14.

In addition, communications system 10 based on magnetic inductance may operate on a carrier signal having a frequency less than those signals used in RF based technologies. For example, in one embodiment, communication system operations on a carrier signal having a frequency about 11 megahertz (MHz) to about 15 MHz. Transmitter 16 operating in this lower frequency range may consume less power than a transmitter that transmits signals in the ultra high radio frequency range (typically about 300 MHz to about 3000 MHz). For example, when compared to a communication system that operates at a frequency of about 2.4 gigahertz (GHz), transmitter 16 (or an amplifier used in conjunction with transmitter 16) of communication module 12 requires less current to transmit a magnetic field at the lower frequency than the higher frequency communication system. An amplifier running at the 2.4 GHz frequency range may require several milliamps of current, while an amplifier running at a 11.5 MHz range may only require a few hundred microamps of current.

Within first communication module 12, processor 18 includes the control and drive circuitry for transmitter 16 and is electrically coupled to transmitter 16. In one aspect of its functionality, transmitter 16 emits magnetic field 32 carrying information under the control of processor 18. Processor 18 also includes a modulator to modulate magnetic field 32. Modulated magnetic field 32 differs from a passive produced magnetic field in that processor 18 (i.e., the modulator) varies the parameters of magnetic field 32 (e.g., amplitude, phase, and frequency) in order to create a signal that carries encoded information. The information to be encoded may be user specified, such as identification information, a data file, a voice file, and so forth.

Processor 18 may include drive circuitry similar to write electronics used in hard disc drives. That is, in embodiments in which transmitter 16 is a coil (i.e., a solenoid), processor 18 may include the drive circuitry to product a time-varying “write” current to flow through the conductive coils of transmitter 16, which in turn produces a time-varying magnetic field 32 that is emitted in from communication module 12. As described in further detail below, MR sensor 22 of receiving communication module 14 may sense this time-varying magnetic field 32 that may be read by MR sensor 22 of the receiving communication module 14.

Transmitter 16 may be coupled to power source 21, which may be a relatively small rechargeable or non-rechargeable battery, or an inductive power interface that receives inductively coupled energy. In other embodiments, power source 21 may be an energy harvest device that is configured to gather energy from an external source, such as body heat, mechanical movement of the body or parts of communication module 12 or the sun, in which case power source 21 may include a solar cell and associated circuitry. In the case of a rechargeable battery, power source 21 similarly may include an inductive power interface for receiving of recharge power from an emitting power source. In the case of a non-rechargeable battery, communication module 12 may be configured to provide access to power source 21 in order to allow a user to replace power source 21 upon depletion of the power stored therein.

Memory 20 may store data to be transmitted by transmitter 16. Memory 20 is optionally included in communication module 12 and in other embodiments, first communication module 12 may not include memory 20. Memory 20 may store information to be transmitted by transmitter 16, such as identification data when communication system 10 is used in a wireless identification system (e.g., a keyless entry system). Memory 20 may also store information inputted by a user, such as data copied from a personal computer hard disc drive.

MR sensor 22 may be any solid magnetic field sensor, other than a solenoid, such as an anisotropic magnetoresistive (AMR) sensor, giant magnetoresistive (GMR) sensor, tunneling magnetoresistive (TMR) sensor, extraordinary magnetoresistive (EMR) sensor, Hall sensor, flux gate sensor, giant magnetoimpedance (GMI) sensor, and so forth. Incorporating MR sensor 22 into communication module 14 may allow for potentially higher information transfer rates between first communication module 12 and second communication module 14 as compared to systems including a solenoid receiver. The higher capacity information transfer rate is at least partially attributable to the fact that a solenoid detects changes in magnetic flux (typically indicated as dB/dt), whereas MR sensor 22 is configured to detect the actual magnetic field (typically indicated as H or B). Furthermore, MR sensor 22 (and solid magnetic field sensors generally) exhibit less impedance than solenoids, which further increases the rate of information transfer between communication modules 12, 14 at the same power level.

Incorporating MR sensor 22 into communication module 14 may also allow for a more compact design than communication modules incorporating a solenoid receiver because the same or greater sensitivity may be achieved with a smaller sized MR sensor 22. As previously described, the sensitivity of a coil receiver may be increased by increasing the number of turns of wire, which increases the size of the coil receiver. On the other hand, the sensitivity of a solid magnetic field sensor such as MR sensor 22 does not exhibit such reliance on the size of sensor.

MR sensor 22 may be in a continuous on-state in which MR sensor 22 is in a fully operational mode and ready to sense magnetic field 32. In other embodiments, MR sensor 22 may be switch activated in order to conserve power and to extend the life of power source 28. For example, a user may manually activate a switch to provide power to MR sensor 22 when information retrieval from a transmitting communication module 12 is desired. MR sensor 22 may be in an off or low power mode (i.e., a sleep mode) until the controller within processor 24 is activated by a switch. Alternatively, MR sensor 22 may be signal activated. For example, magnetic field 32 may include a signal component that is configured to be received by MR sensor 22 (while MR sensor 22 is in a low power (or sleep) state), which then causes processor 24 to fully activate MR sensor 22.

Processor 24 of second communication module 14 includes the read circuitry for MR sensor 22, and is electrically coupled to MR sensor 22. Processor 24 may include circuitry similar to reader electronics used in hard disc drives in order to “read” magnetic field 32 sent out by transmitter 14. For example, in one embodiment, when communication module 14 is placed near magnetic field 32 emitted by communication module 12, a resistance of MR sensor 22 fluctuates in response to the variations in magnetic flux emanating from magnetic field 32. By providing a sense current through MR sensor 22, processor 24 may measure resistance of MR sensor 22 and decipher the information carried by magnetic field 32.

In one embodiment, the variations in resistance of MR sensor 22 generate a variation in voltage due to electromagnetic field effects. Processor 24 may then process the voltage variation to extract coded information from magnetic field 32. Memory 26 may store the sensor signals from MR sensor 22 and/or store data processed from the sensor signals received by MR sensor and decoded by processor 24. Memory 26 is optionally included in communication module 14 and in other embodiments, second communication module 14 may not include memory 26.

Power source 28 is similar to power source 21 of first communication module 12. In some embodiments, first communication module 12 and/or second communication module 14 are integrated with another device that has its own power source, such as a mobile phone or a personal digital assistant. In such embodiments, first communication module 12 and/or second communication module 14 may not include respective power sources 21, 28.

In embodiments in which communication module 14 includes magnetic antenna 30, magnetic antenna 30 may be positioned near MR sensor 22 in order to enhance the performance of MR sensor 22. That is, regardless of the particular type of MR sensor receiver 22 incorporated into second communication module 14, a magnetic antenna 30 may optionally be incorporated into second communication module 14 in order to help collect magnetic flux from magnetic field 32. Magnetic antenna 30 may include, for example, a high permeability material, such as a nickel iron (NiFe) alloy. By collecting magnetic flux, the efficiency of MR sensor receiver 22 may be increased by effectively increasing the sensitivity of MR sensor 22. However, magnetic antenna 30 is not required for MR sensor 22 to sense a magnetic field.

Processors 18 of first communication module 12 and processor 24 of second communication module 14 may each include a microprocessor, a controller, a DSP, an ASIC, an FPGA, discrete logic circuitry, or the like. In addition, each memory 20 and 26 may include any volatile or non-volatile media, such as a RAM, ROM, NVRAM, EEPROM, flash memory, and the like.

Information may be transferred between first communication module 12 and second communication module 14 at any suitable rate, such as rates between about tens of megabits per second and a few gigabits per second. The rate may be adjusted to suit the particular application into which communication system 10 is incorporated. The rate of information transfer may be adjusted by adjusting various parameters of communication modules 12, 14, such as the power that drives transmitter 16 of first communication module 12 and MR sensor receiver 22 of second communication module 14, and the sensitivity of MR sensor receiver 22. In order to increase the information transfer rate in other embodiments, communication module 12 may include multiple transmitters and communication module 14 may include multiple MR sensors that are locked into a respective transmitter. Information may be transferred in parallel between the multiple transmitters and multiple MR sensor receivers to increase the rate of information transmission.

Magnetic field 32 typically emanates from transmitter 16 in concentric circles, while many RF information transmission systems emanate an RF field in a particular direction or pattern. The concentric nature of magnetic field 32 may help minimize interruptions in the transmission of information from transmitting communication module 12 to receiving communication module 14 as compared to RF based communication systems. A strength of magnetic field 32 decreases with distance (e.g., strength of magnetic field=1/r³, where r is the distance from transmitter 16). Accordingly, the range of the communication signal emitted by communication module 12 may be limited to relatively short distances. The relatively short range of magnetic field 32 may be useful for achieving secure communication between communication modules 12, 14. In contrast, some RF based communication systems that transmit a communication signal that propagates 10 meters or more may be less secure because of the potential for interfering devices or persons increase with an increase in the communication signal range.

Magnetic field 32 is a vector field, and accordingly, the relative orientation between transmitter 16 and MR sensor 22 may affect the strength of magnetic field 32 received by MR sensor 22. In order to increase the strength of magnetic field 32 without substantially increasing the power consumed by transmitter 16, transmitter 16 may be designed to include two or more solenoids that are arranged to lie in different planes, which may or may not be orthogonal to each other.

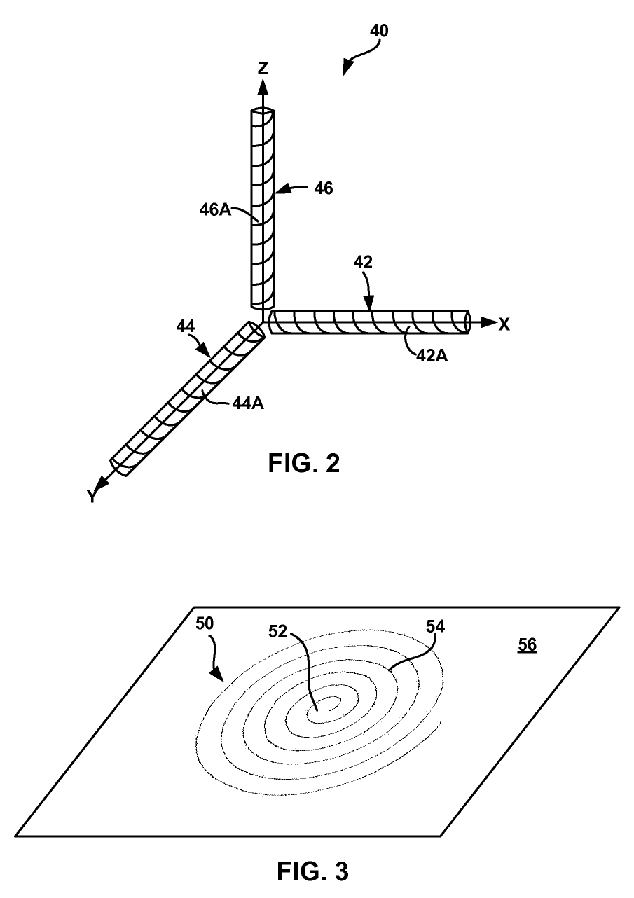

FIG. 2 is a schematic perspective view of one embodiment of transmitter 40 that is configured to broadcast a magnetic field in at least three orthogonal directions (i.e., along orthogonal x-y-z axes, which are shown in FIG. 2). In particular, transmitter 40 includes first solenoid 42 oriented along the x-axis, second solenoid 44 oriented along the y-axis, and third solenoid 46 oriented along the z-axis. While solenoids 42, 44, and 46 are shown to be connected to each other, in other embodiments, solenoids 42, 44, and 46 may be both mechanically and electrically separate from each other. In some embodiments, wires 42A, 44A, and 46A of solenoids 42, 44, and 46, respectively, are connected in series to processor/controller 18, while in other embodiments, wires 42A, 44A, and 46A are separately connected to processor/controller 18.

By broadcasting in at least three directions that are generally perpendicular to each other, transmitter 40 broadcasts a more comprehensive magnetic field than would be possible with a single solenoid that is oriented in one direction. Transmitter 40 essentially emits a magnetic field in three dimensions, which, as a result, may be referred to as a “three-dimensional” magnetic field. The three-dimensional magnetic field emitted by transmitter 40 increases the likelihood that MR sensor 22 of a receiving communication module 14 will be able to read the magnetic field emitted by transmitter 40. Regardless of the orientation of MR sensor 22 relative to transmitter 40, it is likely that a magnetic field will be emitted in a direction toward MR sensor 22, and that MR sensor 22 will be able to sense the magnetic field. Alternatively, transmitter 40 may be designed to broadcast a magnetic field in two or greater than three orthogonal directions or non-orthogonal directions, rather than three as shown in FIG. 2. Of course, if desired, a single solenoid may also be used as transmitter 16 of communication module 12 (FIG. 1).

FIG. 3 is a schematic perspective view of another embodiment of transmitter 50 that may be used in first communication module 12 of FIG. 1. Transmitter 50 is a substantially flat loop coil (i.e., a “pancake” coil) that substantially lies in one plane. Pancake coil transmitter 50 includes soft magnetic core 52 surrounded by multiple turns of wire 54. Pancake coil transmitter 50 may be formed of any suitable method, such as be electroplating or a technique for forming a printed circuit board. Pancake coil transmitter 50 may be used in place of or in combination with solenoid transmitters, such as solenoids 42, 44, and 46 shown in FIG. 2.

In FIG. 3, pancake coil transmitter 50 is placed on article surface 56, and substantially lies in the same plane as article surface 56. That is, when pancake coil transmitter 50 is placed on a substantially flat article surface 56, pancake coil transmitter 50 does not significantly protrude therefrom, allowing the assembly of transmitter and article surface 56 to maintain a relatively low profile as compared to transmitters including three orthogonal solenoids, as shown in FIG. 2. Pancake coil transmitter 50 is, therefore, useful for achieving a relatively compact design of first communication module 12.

A strength of the magnetic field broadcast by pancake coil transmitter 50 is proportional to the cross-sectional area (measured in a direction along the plane of article surface 56) of pancake coil transmitter 50, as well as the number of turns of wire 54 and the current provided to wire 54. Both the size of soft magnetic core 52 and the number of turns of wire 54 affect the cross-sectional area of pancake coil transmitter 50. The ability to increase the cross-sectional area of pancake coil transmitter 50 and the number of turns of wire 54 without increasing the profile of transmitter 50 enables the strength of the magnetic field broadcast by transmitter 50, and thus, the read range of the magnetic field, to be increased without substantially increasing the power consumed by transmitter 50. That is, rather than increasing the current provided to wires 54 of transmitter 50 to increase the read range of transmitter 50, the cross-sectional area of transmitter 50 may be increased. Alternatively, both the current provided to wire 54 of transmitter 50 and the cross-sectional area of pancake coil 50 may be increased to increase the read range of transmitter 50, or the current provided to wire 54 may be increased to increase the read range of transmitter 50.

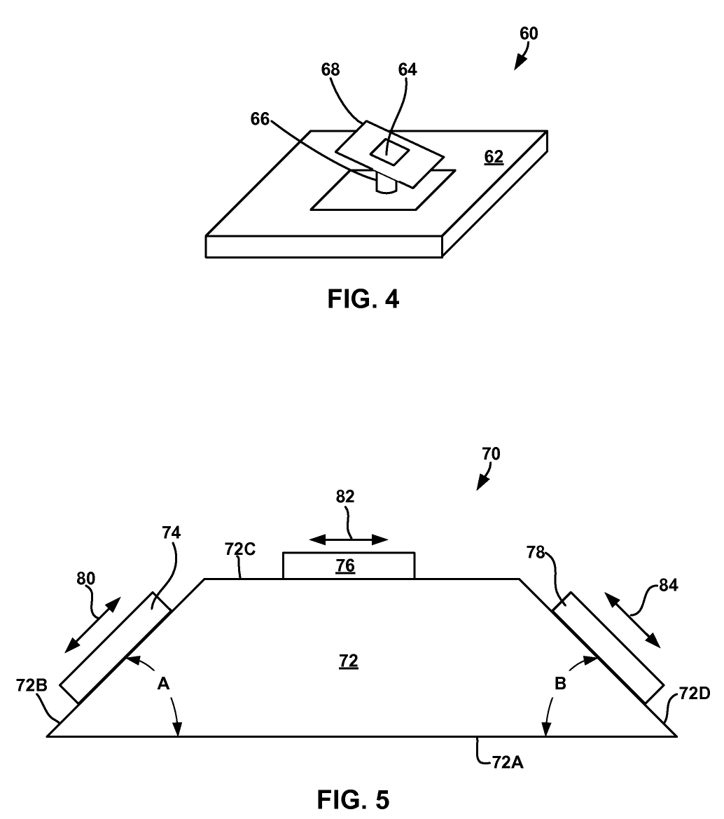

FIG. 4 is yet another embodiment of transmitter system 60 that may be used as transmitter 16 in first communication module 12 of FIG. 1. Transmitter system 60 includes microelectromechanical system (MEMS) 62 and transmitter chip 64 that is mounted on MEMS 62. Arm 66 of MEMS 62 is configured to rotate platform 68 on which transmitter chip 64 is mounted, which allows a single transmitter chip 64 to broadcast a magnetic field in multiple directions. For example, MEMS 62 may be configured to rotate such that transmitter chip 64 is able to transmit a magnetic field in at least three orthogonal directions with a single transmitter chip 64, rather than three solenoids as shown in the embodiment of transmitter 40 shown in FIG. 2. MEMS 62 may rotate transmitter chip 64 under the control of processor 18 or another processor/controller, or MEMS 62 may be configured to automatically rotate transmitter chip 64 in a predetermined or random rotation pattern during a predetermined time interval, such as when power is provided to transmitter system 60. In other embodiments, MEMS 62 may be configured to rotate more than one transmitter chip.

MEMS 62 is schematically shown in FIG. 4. MEMS 62 is typically a more complicated device that may be, for example, similar to those MEMS devices used in micromirror systems.

As previously described, transmitter 16 (FIG. 1) may be configured to emit magnetic field 32 having vector components in two or more directions in order to increase the likelihood that MR sensor 22 (FIG. 1) is properly oriented relative transmitter 16 to read the magnetic field 32. In other embodiments, MR sensor receiver 22 may be designed to include MR sensors oriented in at least two orthogonal or non-orthogonal directions or arranged in different planes, as shown in FIG. 4. The MR sensor receiver oriented to sense a magnetic field from at least two different directions may be used in addition to or instead of a transceiver that emits a magnetic field in at least two directions (e.g., FIG. 2) or two planes.

FIG. 5 is a schematic plan view of MR sensor assembly 70, which may be incorporated into second communications module 14 of FIG. 1. MR sensor assembly 70 includes substrate 72, and MR sensors 74, 76, and 78 arranged on substrate 72. Substrate 72 defines a first surface 72A, second surface 72B oriented at angle A with respect to first surface 72A, third surface 72C that is substantially parallel to first surface 72A, and fourth surface 72D that is oriented at angle B with respect to first surface 72A. In one embodiment, angles A and B are substantially equal. Furthermore, in other embodiments, first surface 72A and third surface 72C are not substantially parallel.

First surface 72A is configured to mount to an article surface or a surface of a housing of communication module 14. In order to sense magnetic fields emanating from at least three directions, MR sensor 74 is mounted on second surface 72B, MR sensor 76 is mounted on third surface 72C, and MR sensor 78 is mounted on fourth surface 72D. In particular, MR sensor 74 is configured to sense a magnetic field in a first direction 80, while MR sensor 76 is configured to sense a magnetic field in a second direction 82 that is oriented at angle A (or alternatively, oriented at an angle equal to about 360 degrees (°)-A) with respect to the first direction 80. MR sensor 78 is configured to sense a magnetic field in direction 84, which is oriented at angle B (or alternatively, oriented at an angle equal to about 360°-B). A user may manually rotate MR sensor assembly 70 in order to allow MR sensors 74, 76, and 78 to receive the strongest magnetic field signals. For example, when MR sensor assembly 70 is disposed within a housing of second communication module 14, a user may manually rotate the housing in the presence of first communication module 12 as a magnetic field is emitted from transmitter 16 of first communication module 12.

In another embodiment of an MR sensor that is configured to detect a magnetic field in more than one direction, an MR sensor may be mounted on a MEMS device, as shown in FIG. 4 with respect to transmitter system 60. The MEMS device may automatically rotate one or more MR sensors to ensure the MR sensor receives the strongest magnetic field signals.

FIG. 6 is a block diagram of communication system 90 in accordance with another embodiment, in which communication system 90 supports bidirectional communication between first communication module 92 and second communication module 94. First communication module 92 and second communication module 94 are similar to first and second communication modules 12, 14 of communication system 10 (FIG. 1), respectively, except that each communication module 92, 94 includes both a transmitter and a receiver. Thus, both communication modules 92, 94 are configured to transmit and receive information via magnetic field sensing. In particular, first communication module 92 includes transmitter 16, processor/controller 18, memory 20, power source 21, MR sensor 96, and magnetic antenna 98 (which is optional, and thus, shown in phantom lines), and second communication module 94 includes transmitter 100, MR sensor 22, processor/controller 24, memory 26, power source 28, and optional magnetic antenna 30.

MR sensor 96 and magnetic antenna 98 of first communication module 92 are similar to MR sensor 22 and magnetic antenna 30, respectively, of second communication module 94 (which are described above with reference to FIG. 1). Transmitter 100 of second communication module 94 is similar to transmitter 16 of first communication module 92.

Processor/controllers 18, 24 of each communication module 92, 94, respectively, are configured to control respective transmitters 16, 100 and MR sensors 96, 22. Alternatively, transmitters 16, 100 and MR sensors 96, 22 may be controlled by dedicated transmitter or receiver processors/controllers.

As described above, during operation of communication system 90, processor 18 may control transmitter 16 to emit modulated magnetic field 32 carrying information. MR sensor 22 of a receiving communication module 94 may then sense magnetic field 32 and processor 24 may measure changes in resistance of MR sensor 22 (i.e., the “sensor signals”) and decode the sensor signals to demodulate magnetic field 32. In addition to transfer of information from first communication module 92 to second communication module 94, communication system 90 also supports transfer of data from second communication module 94 to first communication module 92. More specifically, processor 24 may control transmitter 100 of second communication module 94 to emit modulated magnetic field 102 carrying information. Magnetic sensor 96 of a receiving communication module 92 may then sense magnetic field 102 (with the aid of magnetic antenna 98 in embodiments in which first communication module 92 includes magnetic antenna 98) and transmit sensor signals to processor 18, which then decodes the sensor signals to retrieve data carried by magnetic field 102. In this way, there is bidirectional communication between communication modules 92, 94.

In some embodiments of communication system 90, the components of first and second communication modules 92, 94 may each be built on a single chip. With respect to first communication module 92, for example, transmitter 16, processor/controller 18, memory 20, MR sensor 96, and magnetic antenna 98 may be integrated into a single chip. In embodiments in which communication system 90 is designed for relatively short-range communication, such as, but not limited to, less than about 50 centimeters, transmitter and MR sensor 96 may have a relatively small size, enabling the chip to maintain a relatively compact design (such as a chip having a cross-sectional size measuring less than or equal to about one square centimeter).

In some cases, it may be undesirable for a receiver of one communication module to sense the magnetic field emitted by the same communication module. Taking first communication module 92 as an example, it may be undesirable for MR sensor 96 of first communication module to sense magnetic field 32 emitted by transmitter 16. Unintentional sensing of magnetic field 32 by MR sensor 96 may have negative effects, such as the unnecessary depletion of power source 21. Communication system 90 may be configured to prevent MR sensor 96 from unintentionally reading magnetic field 32, and MR sensor 22 from unintentionally reading magnetic field 102.

In one embodiment, magnetic fields 32 and 102 may have different frequencies that are locked into the intended MR sensor receiver 22, 96 in order to prevent magnetic sensor 22 of second communication module 94 from sensing magnetic field 102 emitted by transmitter 100 of second communication module 94 and to prevent magnetic sensor 96 of first communication module 92 from sensing magnetic field 32 emitted by transmitter 16 of first communication module 92. In another embodiment, coding and signal lock-in techniques may be used to allow MR sensor 22 to read magnetic field 32 and not magnetic field 102, and MR sensor 96 to read magnetic field 102 and not magnetic field 32. In yet other embodiments, MR sensors 22 and 96 may be switched into an off or sleep (i.e., low power) state when not in use and/or when the respective transmitters 16 and 100 are broadcasting magnetic fields 32, 102. Alternatively, MR sensors 22 and 96 may sense magnetic fields 32, 102, respectively, but the respective processors 24 and 18 may not decode the sensed magnetic field 32, 102, thereby conserving some power. The different embodiments of locking in communication between one MR sensor 22/transmitter 16 or MR sensor 96/transmitter 100 pair described herein may be used alone or in combination with each other.

FIG. 7 depicts another embodiment of communication system 104 that helps prevent MR sensor 96 from unintentionally reading magnetic field 32, and MR sensor 22 from unintentionally reading magnetic field 102. Communication system 104 includes first communication module 106 and second communication module 108, which include the same components as communication modules 92, 94, respectively, of FIG. 6. However, transmitter 16 and MR sensor 96 of first communication module 106 are located on different sides of housing 107 of first communication module 106. Similarly, transmitter 100 and MR sensor 22 of second communication module 108 are disposed on different sides of housing 109 of second communication module 108. A description of first communication module 106 and its MR sensor 96 and transmitter 16 are also applicable to second communication module 108.

In the arrangement of first communication module 106 shown in FIG. 7, the likelihood that MR sensor 96 will sense magnetic field 32 is reduced because MR sensor 96 is facing a different direction than transmitter 16 and the direction in which magnetic field 32 (which is a vector field) is emitted. MR sensor 96 may not receive a strong enough signal from magnetic field 32 because transmitter 16 is broadcasting magnetic field 32 in a direction away from MR sensor 96. Other techniques for preventing MR sensor 96 from sensing magnetic field 32, such as coding and signal lock-in, may not be necessary with the arrangement of first communication module 106 shown in FIG. 7. However, in some embodiments, other signal lock-in (or security) techniques may be used with communication system 104.

Although transmitter 16 and MR sensor 96 are shown in FIG. 7 to be on opposite sides of housing 107 of first communication module 106, in other embodiments transmitter 16 and MR sensor 96 may be any sides of housing 107 so long as they are on different sides. Of course, in the embodiment of first communication module 92 shown in FIG. 6, transmitter 16 and MR sensor 96 are positioned on the same side of housing 107.

Communication systems 10 of FIG. 1, 90 of FIG. 6, and 104 of FIG. 7 utilizing on magnetic induction to transmit and receive information may be incorporated into any suitable system. For example, in one embodiment, first communication module 12 may be a mobile telephone and second communication module 14 may be a wireless headset for the mobile telephone. FIG. 8 is a schematic diagram of another embodiment of an application for which communication systems 10 or 90 may be useful.

FIG. 8 illustrates computing device 110 and external disc drive 112. Computing device 110, which may be, for example, a desktop personal computer or a laptop computer, may include first communication module 92 (FIG. 6), while external disc drive 112 may include second communication module 94. In order to transfer information between computing device 110 and external disc drive 112, such as to back-up data from computing device 110 onto external disc drive 112, transmitter 16 of first communication module 92 may emit magnetic field 32 that essentially creates a wireless personal area network (PAN) around computing device 110. In one embodiment, the PAN has a radius of less than about three meters from computing device 110. When disc drive 112 is positioned within the PAN, MR sensor 22 of second communication module 94 within disc drive 112 may sense magnetic field 32 and processor/controller 24 may retrieve information carried by magnetic field 32.

Although not shown in FIG. 8, data may also be transferred from external disc drive 112 to computing device 110 via magnetic field 102 that is emitted by transmitter 100 (shown in FIG. 6). The information may be transferred at a different time or simultaneously with information carried by magnetic field 32.

Various embodiments of the invention have been described. These and other embodiments are within the scope of the following claims.

1. A wireless communication system comprising:
a first communication module comprising a transmitter configured to generate a modulated magnetic field; and
a second communication module comprising a receiver including a solid magnetic field sensor configured to sense the magnetic field,
wherein information is transferred from the first communication module to the second communication module via the magnetic field.

2. The wireless communication system of claim 1, wherein the transmitter comprises a solenoid.

3. The wireless communication system of claim 1, wherein the transmitter comprises a transmitter assembly comprising at least two transmitters configured to transmit the magnetic field in at least two different directions.

4. The wireless communication system of claim 3, wherein the transmitter comprises a plurality of orthogonally arranged transmitters.

5. The wireless communication system of claim 1, the second communication module further comprising a processor electrically coupled to the solid magnetic field sensor and configured to detect changes in resistance in the solid magnetic field sensor.

6. The wireless communication system of claim 5, wherein the processor is configured to demodulate the magnetic field.

7. The wireless communication system of claim 1, wherein the transmitter comprises a first transmitter and the modulated magnetic field is a first modulated magnetic field and the second communication module comprises a second transmitter configured to generate a second modulated magnetic field, and the solid magnetic field sensor comprises a first solid magnetic field sensor and the first communication module comprises a second solid magnetic field sensor configured to sense the second modulated magnetic field, wherein information is transferred from the second communication module to the first communication module via the second modulated magnetic field.

8. The wireless communication system of claim 1, wherein the solid magnetic field sensor comprises at least one of an anisotropic magnetoresistive sensor, a giant magnetoresistive sensor, a tunneling magnetoresistive sensor, an extraordinary magnetoresistive sensor, a Hall sensor, a flux gate sensor or a giant magnetoimpedance sensor.

9. The wireless communication system of claim 1, wherein the solid magnetic field sensor comprises a solid magnetic field sensor assembly comprising at least two solid magnetic field sensors oriented in different directions.

10. The wireless communication system of claim 9, wherein the solid magnetic field sensor assembly comprises a plurality of orthogonally arranged solid magnetic field sensors.

11. The wireless communication system of claim 1, wherein the first communication module further comprises a microelectromechanical system configured to rotate the transmitter.

12. The wireless communication system of claim 1, wherein the second communication module further comprises a microelectromechanical system configured to rotate the solid magnetic field sensor.

13. The wireless communication system of claim 1, wherein the modulated magnetic field is a first modulated magnetic field, the transmitter comprises a first transmitter and the solid magnetic field sensor comprises a first solid magnetic field sensor, the first communication module further comprising a second transmitter configured to generate a second modulated magnetic field, and the second communication module further comprising a second solid magnetic field sensor configured to sense the second modulated magnetic field, wherein the wireless communication system is configured to transfer information between the first and second communication modules via the first and second modulated magnetic fields substantially in parallel.

14. The wireless communication system of claim 1, wherein a read range of the magnetic field is less than about five meters.

15. A wireless communication device comprising:
a solid magnetic field sensor configured to sense a modulated magnetic field emitted from a transmitting communication device and generate sensor signals based on the magnetic field; and
a processor coupled to the solid magnetic field sensor and configured to demodulate the magnetic field to retrieve information from the magnetic field.

16. The wireless communication device of claim 15, further comprising a memory coupled to the processor to store at least one of the sensor signals or the information retrieved from the magnetic field.

17. The wireless communication device of claim 15, wherein the solid magnetic field sensor comprises at least one of an anisotropic magnetoresistive sensor, a giant magnetoresistive sensor, a tunneling magnetoresistive sensor, an extraordinary magnetoresistive sensor, a Hall sensor, a flux gate sensor or a giant magnetoimpedance sensor.

18. The wireless communication device of claim 15, wherein the solid magnetic field sensor comprises a solid magnetic field sensor assembly comprising at least two solid magnetic field sensors oriented in different directions.

19. The wireless communication device of claim 15, further comprising a magnetic antenna coupled to the solid magnetic field sensor.

20. The wireless communication device of claim 15, wherein the modulated magnetic field comprises a first modulated magnetic field, the system further comprising a transmitter configured to generate a second modulated magnetic field.

21. The wireless communication device of claim 20, wherein the transmitter comprises a transmitter assembly comprising at least two transmitters configured to transmit the second modulated magnetic field in at least two different directions.

22. The wireless communication device of claim 15, further comprising a microelectromechanical system configured to rotate the solid magnetic field sensor.

23. A method of wireless communication, the method comprising:
emitting a modulated magnetic field via a transmitter;
sensing the modulated magnetic field via a solid magnetic field sensor;
generating a sensor signal based on the sensed modulated magnetic field; and
processing the sensor signal from the solid magnetic field sensor to demodulate the magnetic field.

24. The method of claim 23, wherein the solid magnetic field sensor comprises at least one of an anisotropic magnetoresistive sensor, a giant magnetoresistive sensor, a tunneling magnetoresistive sensor, an extraordinary magnetoresistive sensor, a Hall sensor, a flux gate sensor or a giant magnetoimpedance sensor.
